(19) United States
(12) Patent Application Publication
(10) Pub. No.: US 2019/0035224 A1
(43) Pub. Date: Jan. 31, 2019

(54) SYSTEMS AND METHODS FOR PROVIDING A POKER GAME TO A PLURALITY OF PLAYERS

(71) Applicant: Boyd Gaming Corporation, Las Vegas, NV (US)

(72) Inventor: Garrett Akira Okahara, North Las Vegas, NV (US)

(21) Appl. No.: 15/660,652

(22) Filed: Jul. 26, 2017

(51) Int. Cl. G07F 17/32

(52) U.S. Cl. CPC G07F 17/3293; G07F 17/3288; G07F 17/3276; G07F 17/3223; G07F 17/3248; G07F 17/3209; G07F 17/3246

(57) ABSTRACT

Methods and systems including electronic gaming machines and computing devices provide a poker game to a plurality of players. A required wager is received from at least one player, and a first set of player cards is dealt to each of the players. A predetermined number of community cards is automatically dealt to the players without first receiving a wagering decision from any of the players. A wagering decision is then received from each player during a first wagering round and an additional community card is dealt to the community area of the table. A winner of the game is determined.

### FIELD OF THE DISCLOSURE

The present disclosure relates generally to wagering games, and more specifically, to systems and methods for providing a poker game to a plurality of players.

### BACKGROUND

A variety of poker games have been developed over the years. One of the more popular varieties of poker is Texas Hold 'Em poker. In Texas Hold 'Em poker, there are small and big blind positions located to the left of a dealer button position. These small and big blind positions on the table require the players in those positions to place “forced bets”, meaning the players in those positions must put money in the pot before receiving their cards. These forced bets effectively seed the pot and start the game play of the poker game. Players are dealt two cards face down, with the last player (in the button position) receiving his or her cards last. The betting then starts with the player left of the big blind. He or she must then put in the big blind amount to remain in play (“call”), double the big blind amount if he or she has a strong hand (“raise”), or throw the hand away if it is a weak hand (“fold”). This continues clockwise around the table, and each player must contemplate the strength of his or her hand. Most players will fold unless they have a specific combination of cards that justifies putting their money into the pot and playing. A conventional strategy is to fold unless the first two cards include pairs, suited connectors, or face cards. Many times players look down at two “unplayable” cards, and throw them away without even being able to see the flop. This is often boring for the player, and also does not create much action at the table. For example, these “unplayable” hands typically occur more frequently than the playable hands, and players may fold their hands 5 or more times in a row before being dealt a hand that satisfies their criteria for playing the hand.

In addition, if players often fold their hands before the flop is dealt, wagering activity may be decreased during the poker game. Since casinos or other gaming establishments often generate revenue by taking a percentage of the pot (a “rake”), the casinos and gaming establishments may not generate enough revenue to justify the space that the poker tables occupy on a casino floor.

The present disclosure is aimed at solving one or more of the problems identified above.

### SUMMARY

In one embodiment, a system includes a plurality of electronic gaming machines. Each electronic gaming machine includes a wager input device that accepts a physical item associated with a monetary value, a player input device configured to receive an input representative of a wager amount from a player operating the electronic gaming machine, a display device and a processor. The processor is configured to add the monetary value to a credit balance of the player, and reduce the credit balance by the wager amount. Each electronic gaming machine also includes a cash out device configured to dispense at least a portion of the credit balance in the form of a physical object. The system also includes a server coupled to each of the plurality of electronic gaming machines. The server includes a processor configured to provide a poker game to a plurality of players operating a respective electronic gaming machine of the plurality of electronic gaming machines, wherein the poker game includes a virtual poker table displayed on the display device of each electronic gaming machine. The processor also is configured to receive an input associated with a required wager entered by at least one player of the plurality of players, deal a first set of player cards to each of the plurality of players, and automatically and without receiving a wagering decision from any of the plurality of players, deal a predetermined number of community cards to a community area of the virtual poker table, wherein each player of the plurality of players is able to use the community cards to form a hand in conjunction with the first set of player cards dealt to each player. The processor also is configured to receive a wagering decision from each player of the plurality of players during a first wagering round, deal an additional community card to the community area of the table, determine a winning player, and determine an award to be received by the winning player. The processor of the electronic gaming machine associated with the winning player is further configured to add the award to the credit balance of the player, receive an input from the player to initiate a cash out operation, and cause the cash out device to dispense at least a portion of the credit balance in the form of a physical object.

In another embodiment, a system includes a plurality of computing devices. Each computing device includes a player input device configured to receive an input representative of a wagering decision from a player operating the computing device, a display device configured to display a poker game including a virtual poker table, and a processor configured to present the poker game to the player on the display device. The system also includes a server coupled to each of the plurality of computing devices. The server includes a processor configured to provide the poker game to each computing device to cause each computing device of a plurality of computing devices to present the poker game to a respective player of a plurality of players, receive an input associated with a required wager entered by at least one player of the plurality of players, and deal a first set of player cards to each of the plurality of players. The processor is configured to automatically and without receiving a wagering decision from any of the plurality of players, deal a predetermined number of community cards to a community area of the virtual poker table, wherein each player of the plurality of players is able to use the community cards to form a hand in conjunction with the first set of player cards dealt to each player. The processor is also configured to receive a wagering decision from each player of the plurality of players during a first wagering round, deal an additional community card to the community area of the table, determine a winning player, and determine an award to be received by the winning player.

In yet another embodiment, a method of providing a game of poker to a plurality of players at a poker table includes receiving a first required wager from a first player of a plurality of players, receiving a second required wager from a second player of the plurality of players, and dealing a first set of player cards to each of the plurality of players. The method also includes automatically and without receiving a wagering decision from any of the plurality of players, dealing a predetermined number of community cards to a community area of the table, wherein each player of the plurality of players is able to use the community cards to form a hand in conjunction with the first set of player cards dealt to each player. The method also includes receiving a wagering decision from each player of the plurality of players during a first wagering round, dealing an additional community card to the community area of the table, and determining a winner of the game from among the players remaining in play.

### BRIEF DESCRIPTION OF THE DRAWINGS

Advantages of the present disclosure will be readily appreciated, as the same becomes better understood by reference to the following detailed description, when considered in connection with the accompanying drawings. Non-limiting and non-exhaustive embodiments of the present disclosure are described with reference to the following figures, wherein like numerals refer to like parts throughout the various views unless otherwise specified.

FIG. 1 is a block diagram of a system that may be used to provide a poker game to a plurality of players using a plurality of electronic gaming machines.

FIG. 2 is a block diagram of electronic gaming machine components that may be used with the electronic gaming machines shown in FIG. 1.

FIG. 3 is a block diagram of another system that may be used to provide a poker game to a plurality of players using a plurality of computing devices.

FIG. 4 is a block diagram of computing device components that may be used with the computing devices shown in FIG. 3.

FIG. 5 is a block diagram of another system that may be used to provide a poker game to a plurality of players using a physical poker table.

### DETAILED DESCRIPTION

The systems and methods described herein provide a poker game to a plurality of players. The poker game may be implemented on a plurality of electronic gaming machines that are coupled to a server by a network. Alternatively, the poker game may be implemented as an online poker game that is presented to players on a plurality of computing devices coupled to a server. Still alternatively, the poker game may be implemented on a physical poker table using physical poker cards.

When the poker game is started, a button position, a small blind position, and a big blind position are determined. The player in the small blind position is required to place a small blind wager while the player in the big blind position is required to place a big blind wager. Thus, the small and big blinds are required wagers that must be placed by the players in the small and big blind positions in order to start the game play of the poker game. After the small and big blind wagers are placed, a first set of hole cards is dealt to each player face down or in a manner that is otherwise designed to obscure the cards from other players than the player to whom the cards were dealt. In one embodiment, two hole cards are dealt to each player. Alternatively, four hole cards, or any other suitable number of hole cards, may be dealt to the players.

After the hole cards are dealt, a first set of community cards are automatically dealt to a community area for use by all of the players. In a specific embodiment, no wagering decisions are received between the time the big blind wager was placed and the time that the first set of community cards is dealt. For example, the players may be prevented from inputting or entering any wagering decisions until the first set of community cards is dealt. After the first set of community cards is dealt, the player in the next clockwise position from the big blind position enters a wagering decision, and the remaining players also successively enter respective wagering decisions in a first wagering round.

After the first wagering round has completed, another community card is dealt to the community area. A second round of wagering begins in which each player who remains in the poker game enters a wagering decision. If two or more players remain after the second round of wagering has completed, a final community card is dealt to the community area. A final, third wagering round begins in which each player remaining in play enters a wagering decision. If two or more players remain in play after the third wagering round completes, the players enter a showdown in which the player with the highest ranked hand wins.

Accordingly, the systems and methods described herein enable players to have a maximum of 3 wagering rounds after the blind wagers have been posted (i.e., after the flop, after the turn, and after the river), as opposed to traditional Texas Hold 'Em poker in which the players have a maximum of 4 wagering rounds after the blinds have been posted (i.e., before the flop, after the flop, after the turn, and after the river). For example, the game servers, electronic gaming machines, computing devices, and/or dealers described herein may only provide or allow wagering decisions to occur during the 3 wagering rounds such that the game servers, electronic gaming machines, computing devices, and/or dealers may prevent any wagering decisions from being received during any other wagering round (e.g., a pre-flop wagering round) and may prevent any other wagering round from occurring.

Accordingly, the poker game described herein may significantly increase a speed of play and may increase an enjoyment of the game by the players since the players may be able to play more hands. For example, by eliminating the pre-flop wagering, the players are able to see the cards of the flop and may have many more opportunities to make a strong hand as compared to the traditional Texas Hold 'Em games where a player had to decide if he or she had a hand worth playing solely based on viewing the hole cards.

In addition, since more players may remain in play after the flop is dealt, the amount of money wagered during each game and/or per hour may be increased as compared to traditional poker games. The increase in player enjoyment and excitement may also encourage the players to wager more. This increase in wagering activity is counterintuitive since there may now be fewer wagering rounds in which the players are able to wager as compared to traditional Texas Hold 'Em poker.

In addition, a strategy used in the poker game described in the present embodiment may be different than a strategy used in traditional poker games. For example, the players in the presently described poker game are able to see the cards of the flop before entering any wagering decisions. Thus, the traditional strategy of only playing hands in which the player's hole cards include a pair, suited connectors, or face cards in not an optimal strategy for the presently described game. As a result, the change in strategy relating to the presently described poker game adds to the excitement, engagement, and enjoyment of the game by the players.

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

In an alternative embodiment, an additional blind wagering position may be added to compensate for the loss of the pre-flop wagering round for any of the electronic gaming machine, online poker, and table game embodiments described herein. For example, instead of two blind positions (e.g., the small blind position and the big blind position), a third blind position may be added such that the player in the position before the small blind position or the player in the position after the big blind position may be required to post a blind wager (a third blind) before the player cards are received. The amount of the third blind may be half of the small blind amount, twice the amount of the big blind amount, equal to the small blind amount, equal to the big blind amount, or any other suitable amount. In a specific embodiment, the third blind may be the same as the small blind so that the game includes two small blinds (and associated small blind player positions) and one big blind. In such a manner, an amount of wagering activity may be increased while still retaining the benefit of the removal of the pre-flop betting discussed herein. While in this embodiment, only one additional blind is added, it should be recognized that any suitable number of blinds (and blind player positions) may be added as desired.

In another embodiment, the dealing of the community cards (sometimes referred to as the board) can be modified. For example, instead of dealing a three card flop, a one card turn, and a one card river as described herein, the game may include dealing a two card primary flop, a one card secondary flop, a one card turn, and a one card river. After each set of community cards is dealt, a corresponding wagering round may be initiated. Thus, after the two card primary flop is dealt, the players may engage in a first wagering round. After the one card secondary flop is dealt, the players may engage in a second wagering round. Third and fourth wagering rounds may follow the dealing of the turn and river cards, respectively, in a similar manner. In this manner, an amount of wagering may be increased due to the additional wagering rounds while retaining the benefit of the removal of the pre-flop betting discussed herein.

Reference throughout this specification to “one embodiment”, “an embodiment”, “one example” or “an examples” means that a particular feature, structure or characteristic described in connection with the embodiment of example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system”. Furthermore, the present invention may take the form of a computer program product embodied in any tangible media or expression having computer-usable program code embodied in the media.

Any combination of one or more computer-usable or computer-readable media (or medium) may be utilized. For example, a computer-readable media may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present invention may be written in any combination of one or more programming languages.

Several (or different) elements discussed below, and/or claimed, are described as being “coupled”, “in communication with” or “configured to be in communication with”. This terminology is intended to be non-limiting, and where appropriate, be interpreted to include without limitation, wired and wireless communication using any one or a plurality of suitable protocols, as well as communication methods that are constantly maintained, are made on a periodic basis, and/or made or initiated on an as needed basis.

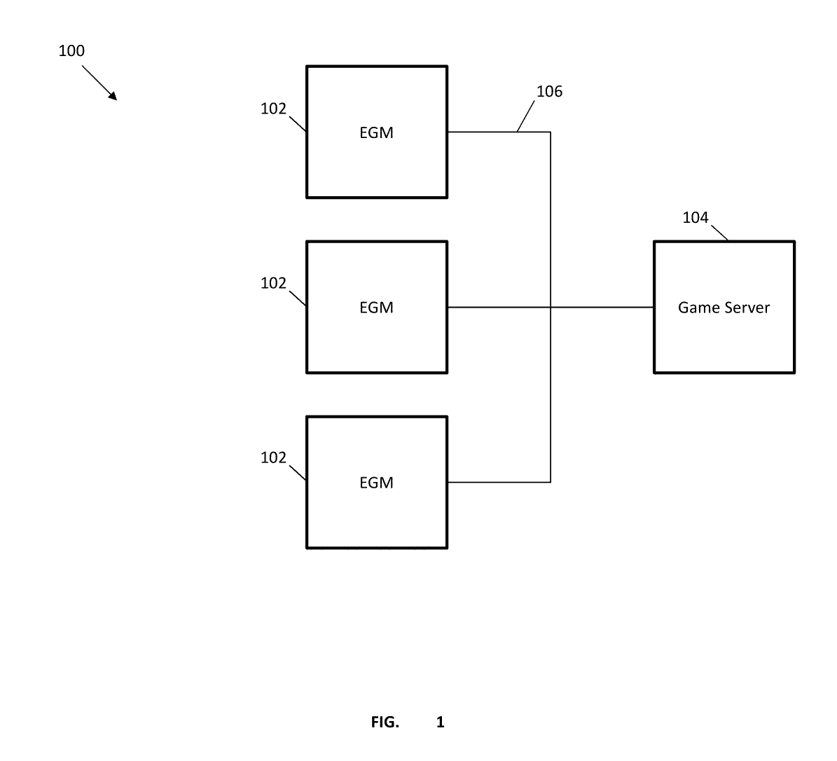

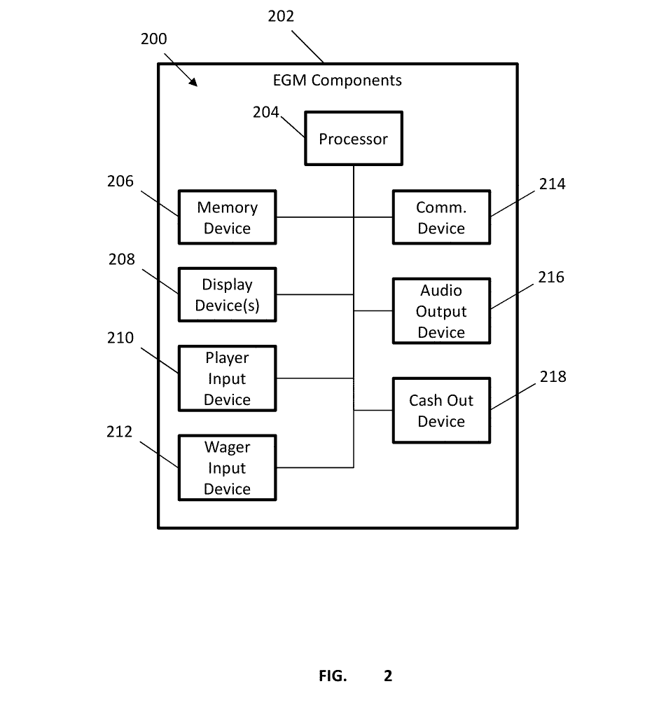

FIG. 1 is a block diagram of a system 100 that may be used to provide a game of poker to a plurality of players. In the example illustrated in FIG. 1, system 100 includes a plurality of electronic gaming machines (EGMs) 102 that are coupled to at least one server, such as a game server 104, via a network 106. Each EGM 102 may include a plurality of EGM components 200 that are illustrated and described with reference to FIG. 2. Game server 104 may include at least one processor (not shown) for controlling the operation of game server 104 and for performing the functions of game server 104 described herein.

Referring to FIG. 1, each EGM 102 may be operated by a respective player to play a game of poker. In one embodiment, the game of poker is implemented on each EGM 102 while the gameplay of each EGM 102 is coordinated by game server 104 (i.e., by a processor of game server 104). Accordingly, each player may play the game of poker on a respective EGM 102 in a networked manner with each other player playing on respective EGMs 102. Alternatively, the game of poker may be implemented on game server 104 and may be communicated to each EGM 102 such that each EGM 102 may display game screens and may receive player inputs, wager inputs, and wagering decisions associated with the game of poker. In both embodiments, each EGM 102 may transmit the player inputs, wager inputs, and wagering decisions to game server 104. The following embodiments are described in which the game of poker is implemented on each EGM 102 with the understanding that the descriptions may also apply to the embodiment in which the game of poker is implemented on game server 104 with appropriate modifications.

Each EGM 102 may be coupled to game server 104 to enable each player to play against each other using a respective EGM 102. Accordingly, each player may participate in a joint game of poker by entering inputs representative of wagers, wagering decisions, and gameplay decisions using interfaces of each EGM 102. The inputs of each player are transmitted to game server 104 as discussed in more detail herein.

Referring to FIG. 2, each EGM 102 may include a plurality of EGM components 200 positioned within a housing or cabinet 202, including a processor 204, a memory device 206, a display device 208, a player input device 210, a wager input device 212, a communication device 214, an audio output device 216, and a cash out device 218. Alternatively, one or more of the EGM components 200 may be combined together in some embodiments.

Processor 204 is used to control an operation of EGM 102. Processor 204 may include, for example, a microprocessor, a microcontroller-based platform, a suitable integrated circuit or one or more application-specific integrated circuits (ASIC's). Processor 204 may be a single core processor or a multi-core processor and may be capable of processing multiple threads simultaneously.

Memory device 206 includes one or more computer-readable media that may store computer-executable instructions that are executable by processor 204, for example, to perform the functions of EGM 102. Memory device 206 may also store data usable by processor 204 to implement the games described herein and/or to implement any of the other functions described herein. Memory device 206 may include random access memory (RAM), flash memory, one or more hard disks, and/or other forms of memory including electrically erasable programmable read only memory (EEPROM) or the like. The RAM memory may include non-volatile RAM (NVRAM), magnetic RAM (MRAM), or ferroelectric RAM (FeRAM), and/or any other suitable form of RAM.

Display device 208 may be secured to housing 202 to enable a player to view game content such as a virtual poker table of the poker game as well as the cards and representations of the players playing the poker game. Display device 208 may include one or more monitors, televisions, projectors, plasma displays, liquid crystal displays (LCD), displays based on light emitting diodes (LEDs), displays based on a plurality of organic light-emitting diodes (OLEDs), or any other suitable electronic device or display mechanism. In one embodiment, as described in more detail below, display device 208 includes a touch-screen with an associated touch-screen controller. In a specific embodiment, display device 208 may include a first display coupled to a top portion of housing 202 and a second display positioned below the first display. The first display may display the gameplay of the poker game (or other game) and the second display may display other information related to the poker game or EGM 102, such as wager amounts, an amount of credits available to be used in the game, player reward status, and the like. Alternatively, the position or location of the content displayed on the first and second displays may be switched.

Player input device 210 may include one or more buttons, a keyboard, a mouse, a trackball, a joystick, a touch-screen, a microphone cooperating with a speech recognition module, an optical sensor cooperating with a gesture control device, and/or any other suitable device that enables a player to input data or commands into EGM 102. The player may use player input device 210 to input game play commands and to input wagering decisions during the game, for example.

Wager input device 212 may include an acceptor configured to receive a physical item associated with a monetary value. For example, wager input device 212 may include a bill acceptor configured to receive and identify paper currency input into EGM 102, a scanner configured to identify and read tickets or vouchers having an amount of currency or credits identified therein, an NFC reader configured to receive data representative of an amount of currency or credits to be input into EGM 102 from a mobile phone or other device, and/or any other suitable device that enables EGM 102 to receive an amount of currency or credits to be used during the game. Wager input device 212 may receive the physical item associated with a monetary value, may extract or identify the monetary value associated therewith, and may transmit data to processor 204 indicating the monetary value. In response, processor 204 may add the monetary value to a credit balance stored within EGM 102 for use in the game.

Communication device 214 enables EGM 102 to communicate with other EGMs 102 and/or with game server 104. Communication device 214 may include, for example, a wired Ethernet interface (e.g., using IEEE 802.3), a wireless Ethernet interface (e.g., using IEEE 802.11), a mesh network interface, a Bluetooth interface, a cellular or telephone modem, and/or any other suitable device that enables EGM 102 to communicate with game server 104. In one embodiment, communication device 214 transmits data to, and receives data from, game server 104 via a local area network (LAN), a wide area network (WAN), a casino area network (CAN), the Internet, the public switched telephone network (PSTN), and/or any other suitable network.

Audio output device 216 includes one or more speakers or other devices that enables EGM 102 to output audible and/or inaudible sounds to the player or to another suitable recipient. For example, EGM 102 may control audio output device 216 to generate audible game play sounds related to the poker game and/or to notify casino personnel about the status of EGM 102.

Cash out device 218 may include a bill dispenser, a coin dispenser, or a printer that prints vouchers or tickets having computer-readable indicia representing an amount of credits or currency dispensed to the player. In one embodiment, when a player operates player input device 210 to initiate a cash out operation on EGM 102, processor 204 transmits data to cash out device 218 to cause cash out device 218 to dispense one or more physical items representing the credit balance of the player on EGM 102. For example, processor 204 may transmit data to cash out device 218 indicating an amount of currency to dispense (i.e., corresponding to all or a selected portion of the player's credit balance), or may transmit data to cash out device 218 indicating an amount of currency or credits to print on a voucher that is presented to the player. Processor 204 decreases the credit balance of EGM 102 by the amount of currency or credits dispensed during the cash out operation.

During operation, a player may operate EGM 102 to play a poker game according to the embodiments described herein. In one embodiment, the poker game is played by a plurality of players playing on respective EGMs 102 and is centrally administered or coordinated by game server 104. Accordingly, the players may play against each other in a competitive poker game using their respective EGM 102.

The player may join the poker game by operating a button or other portion of player input device 210. In response, processor 204 transmits a signal to game server 104 and game server 104 causes the player to join the poker game along with two or more other players. As the game play progresses, each player inputs game play commands and wagering decisions using a respective player input device 210, and data representative of the player inputs are transmitted to game server 104. Game server 104, in turn, transmits data representative of each player's inputs and decisions to EGMs 102 associated with each other player to cause the respective EGM 102 to display the results of the inputs.

Turning now to the specific game play of the poker game, a dealer position is first identified based on a position of each player about a virtual poker table. The dealer position may also be referred to as the “button” position and a virtual button may be displayed next to the position of the player identified as the dealer or button position. The player position immediately adjacent to the button position in a clockwise direction around the virtual poker table is referred to as the “small blind” position, and the next player position adjacent to the small blind position in a clockwise direction around the virtual poker table is referred to as the “big blind” position.

The player associated with the small blind position must initially post a wager corresponding to the small blind amount, and the player associated with the big blind position must initially post a wager corresponding to the big blind amount. The small blind may be an amount that is predetermined before the poker game is started, and the big blind may be an amount that is double the small blind. After the small blind and the big blind amounts have been posted, a first set of player cards are dealt to each player playing the poker game. In a specific embodiment, the first set of player cards (“hole cards”) includes two cards that are dealt to each player and that are only viewable by the player receiving the cards. Thus, the hole cards are hidden from every player except the player to which the hole cards were dealt. Each player may use their hole cards to form part of a 5 card poker hand. While the embodiments described herein relate to dealing two cards to each player as hole cards, it should be recognized that any suitable number of cards may be dealt to each player in accordance with one or more variations of the poker game. For example, in an Omaha variation of the presently described poker game, 4 hole cards may be dealt to each player, and each player must use 2 and only 2 of the hole cards in combination with 3 community cards to form their hand.

Unlike in traditional Texas Hold 'Em or Omaha poker, after the first set of hole cards are dealt to each player, a first set of three community cards (referred to as the “flop”) are immediately dealt and displayed in a community area of the poker table without first waiting for the players to enter wagering decisions in a first round of wagering. Thus, with the exception of the players who post the small and big blinds, no other wagers are permitted or received before the first three community cards are dealt. In a specific embodiment, game server 104 and/or EGMs 102 may prevent the players from entering wagering decisions until the first set of community cards are dealt. As a result, the game play of this embodiment of the poker game is faster and may be much more exciting and engaging to players.

Once the first three community cards have been dealt, a first round of wagering is initiated. During this first wagering round, the player immediately following the player in the big blind position enters a wagering decision, such as calling the big blind amount, raising the big blind amount, or folding the hand. Each successive player in a clockwise direction around the virtual poker table then enters respective wagering decisions during the first round of wagering. For example, each player may decide to call the highest wager amount entered by one of the preceding players, may check if the player has already matched the highest wager amount, may raise the highest wagered amount, or may fold (thus exiting the poker game). After the players have completed entering one or more wagering decisions (e.g., after no more raises have occurred), the first round of wagering ends.

After the first round of wagering decisions has completed, game server 104 determines whether at least two players remain in the poker game. If only one player remains, then that player wins the game and the associated pot containing the amounts wagered by the other players (minus a house rake in some embodiments). Thus, game server 104 may determine an award to be provided to the player to be equal to the amount of the pot minus the house rake. If at least two players remain in the game after the first round of wagering has completed, then another community card (referred to as the “turn”) is dealt to the community area of the poker table. A second round of wagering ensues in which each remaining player enters one or more wagering decisions in a similar manner as the first round of wagering. After the players have completed entering one or more wagering decisions (e.g., after no more raises have occurred), the second round of wagering ends.

After the second round of wagering decisions has completed, game server 104 determines whether at least two players remain in the poker game. If only one player remains, then that player wins the game and the associated pot containing the amounts wagered by the other players (minus a house rake in some embodiments). If at least two players remain in the game after the second round of wagering has completed, then a final community card (referred to as the “river”) is dealt to the community area of the poker table. A third round of wagering ensues in which each remaining player enters one or more wagering decisions in a similar manner as the first and second rounds of wagering. After all wagering decisions have been entered, a winner is determined. If only one player remains after the third round of wagering, then game server 104 identifies that player as the winner. Otherwise, if more than one player remains in play after the third round of wagering has completed, the remaining players enter a showdown in which each player selects their best hand of 5 cards. The 5 cards can be any combination of 0, 1, or 2 of the respective player's hole cards with 5, 4, or 3 of the community cards, respectively. The player who has the highest ranked hand is identified as the winner and receives the associated pot containing the amounts wagered by the other players (minus a house rake in some embodiments). Game server 104 may determine an award to be provided to the player to be equal to the amount of the pot minus the house rake.

Each time a player enters a wagering decision through player input device 210 that involves an additional amount to be wagered (e.g., posting of a blind amount, raising, etc.), processor 204 reduces the player's available credit balance by the wagered amount. Conversely, if the player wins the pot, processor 204 increases the player's credit balance by the amount awarded by game server 104, i.e., the pot amount minus any applicable house rake. When the player has finished a play session on EGM 102, the player may cash out the remaining credit balance by initiating a cash out operation through player input device 210 (e.g., by pressing a cash out button or the like). In response, processor 204 causes cash out device 218 to dispense all or a selected portion of the credit balance to the player in the form of physical currency, a voucher or ticket identifying the credit balance, or another suitable representation of the credit balance. The processor 204 deducts the cashed out amount from the credit balance.

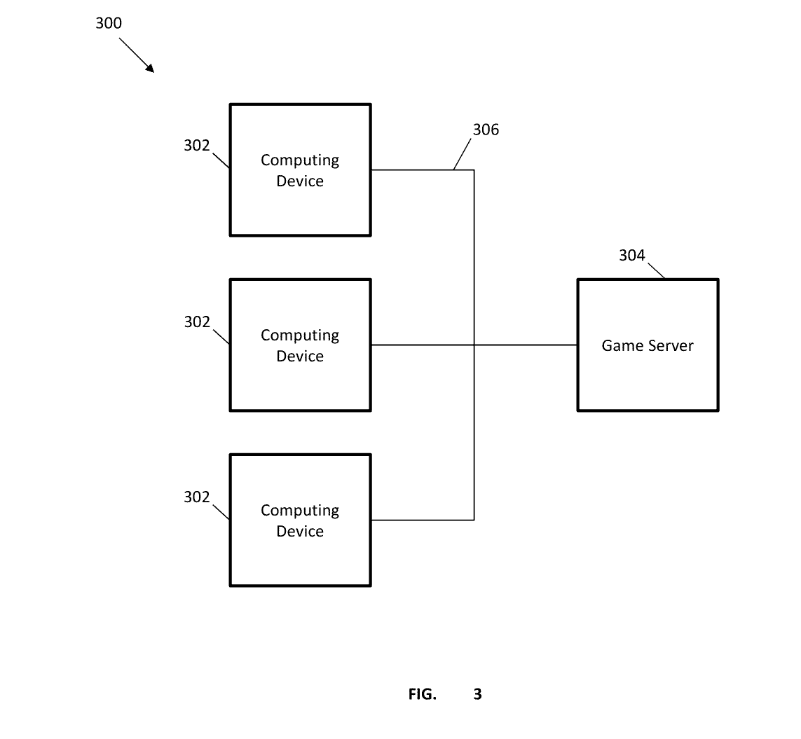

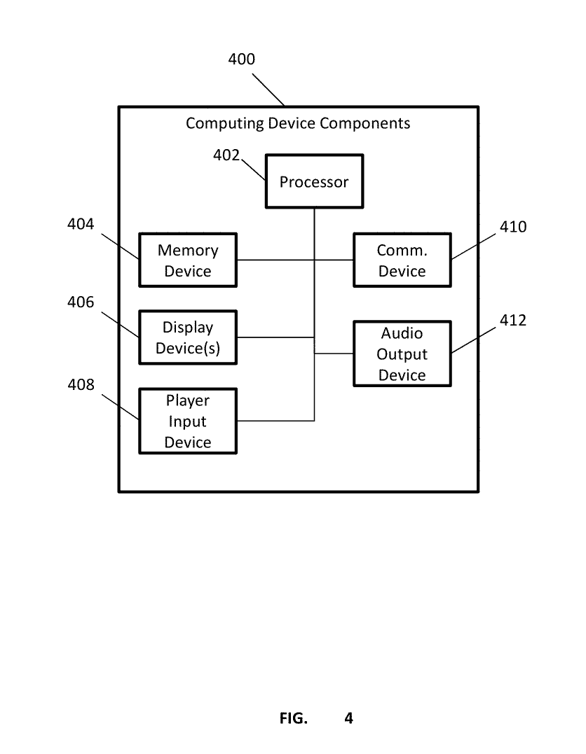

FIG. 3 is a block diagram of another system 300 that may be used to provide a game of poker to a plurality of players. In the example illustrated in FIG. 3, system 300 includes a plurality of computing devices 302 that are coupled to at least one server, such as a game server 304, via a network 306. In the embodiments described herein, computing devices 302 may interact with game server 304 to provide an online poker game to the player of each computing device 302. Each computing device 302 may include a plurality of computing device components 400 that are illustrated and described with reference to FIG. 4. Game server 304 may include at least one processor (not shown) for controlling the operation of game server 304 and for performing the functions of game server 304 described herein.

Referring to FIG. 4, each computing device 302 may be operated by a respective player to play a game of online poker. In one embodiment, the game of poker is implemented on each computing device 302 while the gameplay of each computing device 302 is coordinated by game server 304. Accordingly, each player may play the game of poker on a respective computing device 302 in a networked manner with each other player playing on respective computing devices 302. Alternatively, the game of poker may be implemented on game server 304 and may be communicated to each computing device 302 such that each computing device 302 may display game screens and may receive player inputs, wager inputs, and wagering decisions associated with the game of poker. In both embodiments, each computing device 302 may transmit the player inputs, wager inputs, and wagering decisions to game server 304. The following embodiments are described in which the game of poker is implemented on each computing device 302 with the understanding that the descriptions may also apply to the embodiment in which the game of poker is implemented on game server 304 with appropriate modifications.

Each computing device 302 may be coupled to game server 304 to enable each player to play against each other using a respective computing device 302. Accordingly, each player may participate in a joint game of poker by entering inputs representative of wagers, wagering decisions, and gameplay decisions using player input devices of each computing device 302. The inputs of each player are transmitted to game server 304 as discussed in more detail herein.

Computing devices 302 may include, for example, one or more laptop computers, desktop computers, tablet computing devices, smart phones, wearable computing devices (e.g., smart watches or the like), or any other suitable computing device.

Referring to FIG. 4, each computing device 302 may include a plurality of computing device components 400, including a processor 402, a memory device 404, a display device 406, a player input device 408, a communication device 410, and an audio output device 412. Alternatively, one or more of the computing device components 400 may be combined together in some embodiments.

Processor 402 is used to control an operation of computing device 302. Processor 402 may include, for example, a microprocessor, a microcontroller-based platform, a suitable integrated circuit or one or more application-specific integrated circuits (ASIC's). Processor 402 may be a single core processor or a multi-core processor and may be capable of processing multiple threads simultaneously.

Memory device 404 includes one or more computer-readable media that may store computer-executable instructions that are executable by processor 402, for example, to perform the functions of computing device 302. Memory device 404 may also store data usable by processor 402 to implement the games described herein and/or to implement any of the other functions described herein. Memory device 404 may include random access memory (RAM), flash memory, one or more hard disks, and/or other forms of memory including electrically erasable programmable read only memory (EEPROM) or the like. The RAM memory may include non-volatile RAM (NVRAM), magnetic RAM (MRAM), or ferroelectric RAM (FeRAM), and/or any other suitable form of RAM.

Display device 406 may enable a player to view game content such as a virtual poker table of the poker game as well as the cards and representations of the players playing the poker game. Display device 406 may include one or more monitors, televisions, projectors, plasma displays, liquid crystal displays (LCD), displays based on light emitting diodes (LEDs), displays based on a plurality of organic light-emitting diodes (OLEDs), or any other suitable electronic device or display mechanism. In one embodiment, as described in more detail below, display device 406 includes a touch-screen with an associated touch-screen controller. In a specific embodiment, display device 406 may display the gameplay of the poker game (or other game) and other information related to the poker game, such as wager amounts, an amount of credits available to be used in the game, player reward status, and the like.

Player input device 408 may include one or more buttons, a keyboard, a mouse, a trackball, a joystick, a touch-screen, a microphone cooperating with a speech recognition module, an optical sensor cooperating with a gesture control device, and/or any other suitable device that enables a player to input data or commands into computing device 302. The player may use player input device 408 to input game play commands and to input wagering decisions during the game, for example.

Communication device 410 enables computing device 302 to communicate with other computing devices 302 and/or with game server 304. Communication device 410 may include, for example, a wired Ethernet interface (e.g., using IEEE 802.3), a wireless Ethernet interface (e.g., using IEEE 802.11), a mesh network interface, a Bluetooth interface, a cellular or telephone modem, and/or any other suitable device that enables computing device 302 to communicate with game server 304. In one embodiment, communication device 410 transmits data to, and receives data from, game server 304 via a local area network (LAN), a wide area network (WAN), a casino area network (CAN), the Internet, the public switched telephone network (PSTN), and/or any other suitable network.

Audio output device 412 includes one or more speakers or other devices that enables computing device 302 to output audible and/or inaudible sounds to the player or to another suitable recipient. For example, computing device 302 may control audio output device 412 to generate audible game play sounds related to the poker game.

During operation, a player may operate computing device 302 to play a poker game according to the embodiments described herein. In one embodiment, the poker game is played by a plurality of players playing on respective computing devices 302 and is centrally administered or coordinated by game server 304. Accordingly, the players may play against each other in a competitive online poker game using their respective computing device 302.

The player may join the poker game by operating a button or other portion of player input device 408. In response, processor 402 transmits a signal to game server 304 and game server 304 causes the player to join the poker game along with two or more other players. The player may initially establish a credit balance for use in the game by operating computing device 302 to transfer money or credits from a debit or credit account, for example, to an account associated with the poker game. As the game play progresses, each player inputs game play commands and wagering decisions using a respective player input device 408, and data representative of the player inputs are transmitted to game server 304. Game server 304, in turn, transmits data representative of each player's inputs and decisions to computing devices 302 associated with each other player to cause the respective computing device 302 to display the results of the inputs.

In one embodiment, the specific game play of the poker game is substantially similar to the game play of the poker game described above with respect to FIGS. 1 and 2. Accordingly, in one embodiment, a dealer or button position is first identified based on a position of each player about a virtual poker table displayed by display device 406. A virtual button may be displayed by display device 406 next to the position of the player identified as the dealer or button position.

The player associated with the small blind position must initially post a wager corresponding to the small blind amount, and the player associated with the big blind position must initially post a wager corresponding to the big blind amount. The small blind may be an amount that is predetermined before the poker game is started, and the big blind may be an amount that is double the small blind. After the small blind and the big blind amounts have been posted, a first set of player cards are dealt to each player playing the poker game. In a specific embodiment, the first set of player cards (“hole cards”) includes two cards that are dealt to each player and that are only viewable by the player receiving the cards. Each player may use 0, 1, or 2 of their hole cards to form part of a 5 card poker hand. While the embodiments described herein relate to dealing two cards to each player as hole cards, it should be recognized that any suitable number of cards may be dealt to each player in accordance with one or more variations of the poker game. For example, in an Omaha variation of the presently described poker game, 4 hole cards may be dealt to each player, and each player must use 2 and only 2 of the hole cards in combination with 3 community cards to form their hand.

After the first set of hole cards are dealt to each player, a first set of three community cards (referred to as the “flop”) are immediately dealt and displayed in a community area of the poker table without first waiting for the players to enter wagering decisions in a first round of wagering. Thus, with the exception of the players who post the small and big blinds, no other wagers are permitted or received before the first three community cards are dealt. In a specific embodiment, game server 304 and/or computing devices 302 may prevent the players from entering wagering decisions until the first set of community cards are dealt. As a result, the game play of this embodiment of the poker game is faster and may be much more exciting and engaging to players.

Once the first three community cards have been dealt, a first round of wagering is initiated. During this first wagering round, the player immediately following the player in the big blind position enters a wagering decision, such as calling the big blind amount, raising the big blind amount, or folding the hand. Each successive player in a clockwise direction around the virtual poker table then enters respective wagering decisions during the first round of wagering. For example, each player may decide to call the highest wager amount entered by one of the preceding players, may check if the player has already matched the highest wager amount, may raise the highest wagered amount, or may fold (thus exiting the poker game). After the players have completed entering one or more wagering decisions (e.g., after no more raises have occurred), the first round of wagering ends.

After the first round of wagering decisions has completed, game server 304 determines whether at least two players remain in the poker game. If only one player remains, then that player wins the game and the associated pot containing the amounts wagered by the other players (minus a house rake in some embodiments). If at least two players remain in the game after the first round of wagering has completed, then another community card (referred to as the “turn”) is dealt to the community area of the poker table. A second round of wagering ensues in which each remaining player enters one or more wagering decisions in a similar manner as the first round of wagering. After the players have completed entering one or more wagering decisions (e.g., after no more raises have occurred), the second round of wagering ends.

After the second round of wagering decisions has completed, game server 304 determines whether at least two players remain in the poker game. If only one player remains, then that player wins the game and the associated pot containing the amounts wagered by the other players (minus a house rake in some embodiments). If at least two players remain in the game after the second round of wagering has completed, then a final community card (referred to as the “river”) is dealt to the community area of the poker table. A third round of wagering ensues in which each remaining player enters one or more wagering decisions in a similar manner as the first and second rounds of wagering. After all wagering decisions have been entered, a winner is determined. If only one player remains after the third round of wagering, then game server 304 identifies that player as the winner. Otherwise, if more than one player remains in play after the third round of wagering has completed, the remaining players enter a showdown in which each player selects their best hand of 5 cards. The 5 cards can be any combination of 0, 1, or 2 of the respective player's hole cards with 5, 4, or 3 of the community cards, respectively. The player who has the highest ranked hand is identified as the winner and receives the associated pot containing the amounts wagered by the other players (minus a house rake in some embodiments). Thus, game server 304 may determine an award to be provided to the player to be equal to the amount of the pot minus the house rake.

Each time a player enters a wagering decision through player input device 408 that involves an additional amount to be wagered (e.g., posting of a blind amount, raising, etc.), processor 402 reduces the player's available credit balance by the wagered amount. Conversely, if the player wins the pot, processor 402 increases the player's credit balance by the amount awarded by game server 304, i.e., the pot amount minus any applicable house rake. When the player has finished a play session on computing device 302, the player may cash out the remaining credit balance by initiating a cash out operation through player input device 408 (e.g., by pressing a cash out button or the like). In response, processor 402 causes all or a selected portion of the credit balance to be electronically transferred or credited to a bank account or other identified account of the player. The processor 402 deducts the cashed out amount from the credit balance on computing device 302.

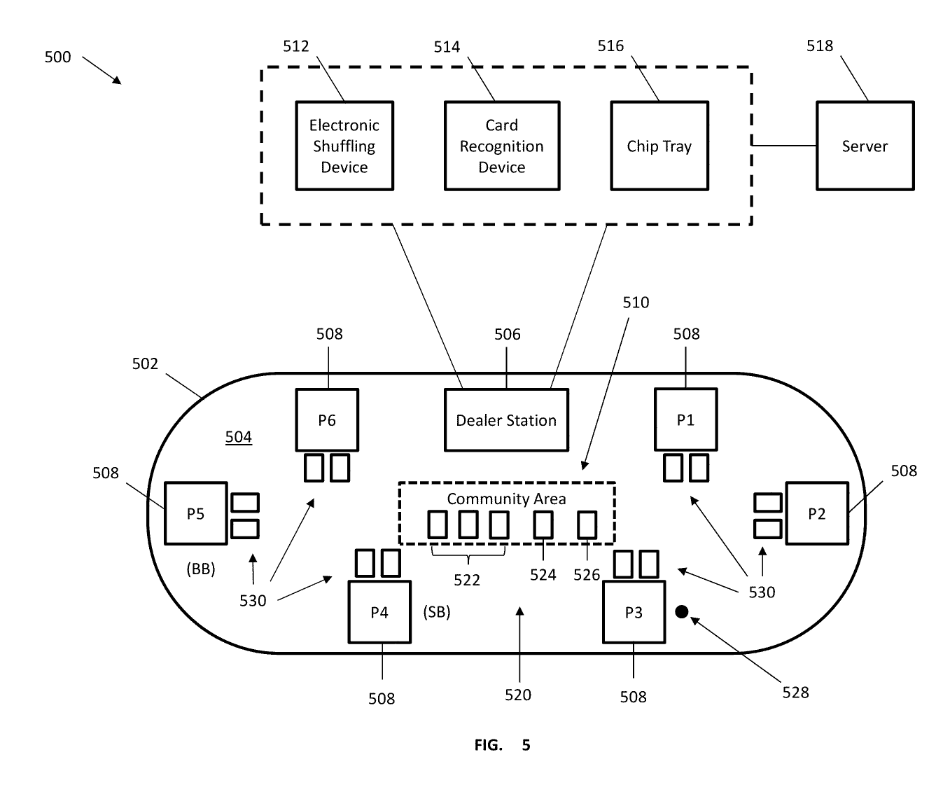

FIG. 5 is a block diagram illustrating another system 500 that may be used to provide a game of poker to a plurality of players. In the example illustrated in FIG. 5, system 500 includes a physical table 502 having a playing surface 504. Table 502 also includes a dealer station 506, a plurality of player stations 508, and a community area 510.

In some embodiments, dealer station 506 includes an electronic shuffling device 512, a card recognition device 514, and a chip tray 516. Alternatively, dealer station 506 may not include one or more of the above-identified devices or components. In one embodiment, one or more of the dealer station devices or components may be communicatively coupled to one or more servers 518.

Electronic shuffling device 512 is configured to automatically shuffle one or more decks of playing cards. A dealer may specify the number of decks to be shuffled, in some embodiments, or electronic shuffling device 512 may be configured to shuffle a predefined number of decks. Electronic shuffling device 512 automatically shuffles the cards and provides the cards to the dealer to be dealt individually or in groups of cards having a predetermined number of cards. Electronic shuffling device 512 may communicate with server 518 to track a number of cards dealt or a number of decks shuffled, for example.

In one embodiment, card recognition device 514 includes an optical sensor for reading images of cards that pass over the optical sensor as the dealer deals the cards, for example. Alternatively, card recognition device 514 may include a wireless tag reader for reading electromagnetic tags embedded within the cards. The tag reader may be a radio frequency identification (RFID) reader that reads RFID tags embedded within the cards, a near-field communication (NFC) reader that reads NFC tags embedded within the cards, or any other suitable wireless tag reader. Card recognition device 514 may be a standalone device coupled to or integrated within table 502, or may be incorporated into electronic shuffling device 512 or another suitable device. Card recognition device 514 may communicate with server 518 to track each particular card that is dealt.

Chip tray 516 may be used for storing poker chips that are used during the poker game. In one embodiment, each poker chip includes a wireless tag, such as an RFID or NFC tag, that identifies the denomination of the poker chip. Accordingly, chip tray 516 may include a wireless tag reader, such as an RFID or NFC tag reader, that automatically reads the tags of each chip stored within chip tray 516 and automatically identifies how many chips of each denomination is stored within chip tray 516. Chip tray 516 may transmit data representative of the identified chips and denominations to server 518 to enable server 518 to track the usage of the chips. Alternatively, chip tray 516 may not be used and wagering activity may occur instead using a touch screen device integrated within, or positioned at each player station 508.

Player stations 508 are designated player positions around player table 502 for each player playing the poker game. Each player station 508 may receive two hole cards that are dealt to the player sitting (or standing) at the player station 508. Alternatively, any suitable number of hole cards may be dealt to each player at each player station 508.

In one embodiment, each player station 508 may include a touch screen device (not shown) that is integrated within, or coupled to, table 502. In such an embodiment, the players may use the touch screen devices to enter wagers or other wagering decisions (e.g., call, fold, etc.). Additionally or alternatively, the touch screen devices may display the player's hole cards as virtual cards within a screen of the touch screen device. Thus, instead of the dealer dealing physical player cards to each player at the player's respective player station 508, the cards may be virtually dealt to each player by server 518 or another suitable device and may be displayed on the respective player's touch screen device.

Community area 510 is a portion of table surface 504 that is designated for displaying community cards 520 that are dealt during the poker game. Specifically, the dealer may deal the flop 522, turn 524, and river 526 cards into community area 510 so that each player may view the respective community cards 520 within community area 510.

Server 518 is coupled to one or more devices of dealer station 506, in one embodiment. In addition, server 518 may be coupled to each touch screen device of each player station 508 in embodiments where the touch screen devices are used. Server 518 includes at least one processor (not shown) for controlling the operation of server 518 and for performing the functions of server 518 described herein. Server 518 may track the cards provided by electronic shuffling device 512 that are then dealt by the dealer, and may track the chips that are removed from chip tray 516 and that are then provided to each player. Accordingly, server 518 may audit the operation of the poker game at table 502. Server 518 may also implement a player reward program, or may interface with a player reward server (not shown) that implements the program. In an embodiment where touch screen devices are used instead of chips for the players' wagering activities, server 518 may communicate with the touch screen devices to establish a credit balance for each player, receive the wagering decisions and associated wager amounts from the players, maintain a credit balance associated with each player, decrease each player's credit balance based on each player's wagering activity, increase a player's credit balance according to an amount won by the player, and/or may automatically credit or transfer currency corresponding to the player's credit balance to an electronic account (such as a bank account) when a player leaves the table or initiates a cash out operation through the touch screen device.

During operation, the poker game is played by a plurality of players seated (or standing) around table 502 at respective player stations 508 and is administered or coordinated by a dealer. The dealer may be a live person in one embodiment. Alternatively, the dealer may be a virtual dealer implemented by server 518 in some embodiments. The following description is based on the dealer being a live person, although the same description may apply to a virtual dealer with appropriate modifications.

In one embodiment, the specific game play of the poker game is substantially similar to the game play of the poker game described above with respect to FIGS. 1 and 2 with the exception that the players may interact with physical playing cards that are dealt by a dealer on the physical poker table 502. Accordingly, in one embodiment, the dealer identifies the player who is in a button position, a player who is in a small blind position, and a player who is in a big blind position. A button 528 or other marker may be placed next to the player station 508 of the player identified as being in the button position. In the embodiment illustrated in FIG. 5, player P3 is in the button position, player P4 is in the small blind (SB) position, and player P5 is in the big blind (BB) position.

The player in the small blind position must initially post a wager corresponding to the small blind amount, and the player in the big blind position must initially post a wager corresponding to the big blind amount. The small blind may be an amount that is predetermined before the poker game is started, and the big blind may be an amount that is double the small blind. After the small blind and the big blind have been posted, the dealer deals a first set of player cards 530 to each player playing the poker game. In a specific embodiment, the first set of player cards 530, or hole cards, includes two cards that are dealt to each player. Each player may use 0, 1, or 2 of their hole cards to form part of a 5 card poker hand. While the embodiments described herein relate to dealing two cards to each player as hole cards, it should be recognized that any suitable number of cards may be dealt to each player in accordance with one or more variations of the poker game. For example, in an Omaha variation of the presently described poker game, 4 hole cards may be dealt to each player, and each player must use 2 and only 2 of the hole cards in combination with 3 community cards to form their hand.

After the first set of hole cards 530 are dealt to each player, the dealer immediately deals a first set of three community cards 522 (referred to as the “flop”) to community area 510 of poker table 502 without first waiting for the players to enter wagering decisions in a first round of wagering. Specifically, the dealer may prevent the players from entering wagering decisions until the first set of community cards 522 are dealt. Thus, with the exception of the players who post the small and big blinds, no other wagers are permitted or received before the first three community cards 522 are dealt.

Therefore, unlike traditional flop poker games, no pre-flop wagering occurs after the small blind and the big blind are posted in the embodiments described herein. Rather, after the blinds are posted, the flop is automatically dealt and presented to the players in community area 510 of table 502. Wagering decisions are then made by each player, starting with the player positioned after the big blind. For example, the players who follow the blinds (e.g., players P6-P3 in the illustrated embodiment) must enter a wagering decision of call, raise, or fold.

Accordingly, once the first three community cards 522 have been dealt, a first round of wagering is initiated. During this first wagering round, the player immediately following the player in the big blind position (e.g., player P6) enters a wagering decision, such as calling the big blind amount, raising the big blind amount, or folding the hand. Each successive player in a clockwise direction around poker table 502 then enters respective wagering decisions during the first round of wagering. For example, each player may decide to call the highest wager amount entered by one of the preceding players, may check if the player has already matched the highest wager amount, may raise the highest wagered amount, or may fold (thus exiting the poker game). After the players have completed entering one or more wagering decisions (e.g., after no more raises have occurred), the first round of wagering ends.

After the first round of wagering decisions has completed, the dealer determines whether at least two players remain in the poker game. If only one player remains, then that player wins the game and the associated pot containing the amounts wagered by the other players (minus a house rake in some embodiments). If at least two players remain in the game after the first round of wagering has completed, then the dealer deals another community card 524 (the “turn”) to community area 510. A second round of wagering ensues in which each remaining player enters one or more wagering decisions in a similar manner as the first round of wagering. After the players have completed entering one or more wagering decisions (e.g., after no more raises have occurred), the second round of wagering ends.

After the second round of wagering decisions has completed, the dealer determines whether at least two players remain in the poker game. If only one player remains, then that player wins the game and the associated pot containing the amounts wagered by the other players (minus a house rake in some embodiments). If at least two players remain in the game after the second round of wagering has completed, then the dealer deals a final community card 526 (the “river”) to community area 510 of poker table 502. A third round of wagering ensues in which each remaining player enters one or more wagering decisions in a similar manner as the first and second rounds of wagering. After all wagering decisions have been entered, a winner is determined. If only one player remains after the third round of wagering, then the dealer identifies that player as the winner. Otherwise, if more than one player remains in play after the third round of wagering has completed, the remaining players enter a showdown in which each player selects their best hand of 5 cards. The 5 cards can be any combination of 0, 1, or 2 of the respective player's hole cards 530 in conjunction with 5, 4, or 3 of the community cards 520, respectively. The player who has the highest ranked hand is identified as the winner and receives the associated pot containing the amounts wagered by the other players (minus a house rake in some embodiments). Thus, the dealer or server 518 may determine an award to be provided to the player to be equal to the amount of the pot minus the house rake and may provide the amount of the award to the player.

In an alternative embodiment, an additional blind wagering position may be added to compensate for the loss of the pre-flop wagering round for any of the electronic gaming machine, online poker, and table game embodiments described herein. For example, instead of two blind positions (e.g., the small blind position and the big blind position), a third blind position may be added such that the player in the position before the small blind position or the player in the position after the big blind position may be required to post a blind wager (a third blind) before the player cards are received. The amount of the third blind may be half of the small blind amount, twice the amount of the big blind amount, equal to the small blind amount, equal to the big blind amount, or any other suitable amount. In a specific embodiment, the third blind may be the same as the small blind so that the game includes two small blinds (and associated small blind player positions) and one big blind. In such a manner, an amount of wagering activity may be increased while still retaining the benefit of the removal of the pre-flop betting discussed herein. While in this embodiment, only one additional blind is added, it should be recognized that any suitable number of blinds (and blind player positions) may be added as desired.

In another embodiment, the dealing of the community cards (sometimes referred to as the board) can be modified. For example, instead of dealing a three card flop, a one card turn, and a one card river as described herein, the game may include dealing a two card primary flop, a one card secondary flop, a one card turn, and a one card river. After each set of community cards is dealt, a corresponding wagering round may be initiated. Thus, after the two card primary flop is dealt, the players may engage in a first wagering round. After the one card secondary flop is dealt, the players may engage in a second wagering round. Third and fourth wagering rounds may follow the dealing of the turn and river cards, respectively, in a similar manner. In this manner, an amount of wagering may be increased due to the additional wagering rounds while retaining the benefit of the removal of the pre-flop betting discussed herein.

Although specific features of various embodiments of the disclosure may be shown in some drawings and not in others, this is for convenience only. In accordance with the principles of the disclosure, any feature of a drawing or other embodiment may be referenced and/or claimed in combination with any feature of any other drawing or embodiment.

This written description uses examples to describe embodiments of the disclosure and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system, comprising:
a plurality of electronic gaming machines, each electronic gaming machine comprising:
a wager input device that accepts a physical item associated with a monetary value;
a player input device configured to receive an input representative of a wager amount from a player operating the electronic gaming machine;
a display device;
a processor configured to:
add the monetary value to a credit balance of the player; and
reduce the credit balance by the wager amount; and
a cash out device configured to dispense at least a portion of the credit balance in the form of a physical object; and
a server coupled to each of the plurality of electronic gaming machines, the server comprising a processor configured to:
provide a poker game to a plurality of players operating a respective electronic gaming machine of the plurality of electronic gaming machines, wherein the poker game includes a virtual poker table displayed on the display device of each electronic gaming machine;
receive an input associated with a required wager entered by at least one player of the plurality of players;
deal a first set of player cards to each of the plurality of players;
automatically and without receiving a wagering decision from any of the plurality of players, deal a predetermined number of community cards to a community area of the virtual poker table, wherein each player of the plurality of players is able to use the community cards to form a hand in conjunction with the first set of player cards dealt to each player;
receive a wagering decision from each player of the plurality of players during a first wagering round;
deal an additional community card to the community area of the table;
determine a winning player; and
determine an award to be received by the winning player,
wherein the processor of the electronic gaming machine associated with the winning player is further configured to:
add the award to the credit balance of the player;
receive an input from the player to initiate a cash out operation; and
cause the cash out device to dispense at least a portion of the credit balance in the form of a physical object.

2. The system of claim 1, wherein the server is further configured to receive wagering decisions during a second wagering round from each player of the plurality of players who remains in play after the additional community card is dealt to the community area.

3. The system of claim 2, wherein the server is further configured to deal a final community card to the community area upon a determination that at least two players remain in play after the wagering decisions have been received during the second wagering round.

4. The system of claim 3, wherein the server is further configured to receive wagering decisions during a third wagering round from each player of the plurality of players who remains in play after the final community card is dealt to the community area.

5. The system of claim 1, wherein each electronic gaming machine is further configured to prevent each respective player from entering a wagering decision between a time the at least one player has entered the required wager and a time in which the predetermined number of community cards has been dealt.

6. The system of claim 1, wherein the server is configured to prevent the electronic gaming machines from receiving wagering decisions in more than three wagering rounds.

7. A system, comprising:
a plurality of computing devices, each computing device comprising:
a player input device configured to receive an input representative of a wagering decision from a player operating the computing device;
a display device configured to display a poker game including a virtual poker table; and
a processor configured to present the poker game to the player on the display device; and
a server coupled to each of the plurality of computing devices, the server comprising a processor configured to:
provide the poker game to each computing device to cause each computing device of a plurality of computing devices to present the poker game to a respective player of a plurality of players;
receive an input associated with a required wager entered by at least one player of the plurality of players;
deal a first set of player cards to each of the plurality of players;
automatically and without receiving a wagering decision from any of the plurality of players, deal a predetermined number of community cards to a community area of the virtual poker table, wherein each player of the plurality of players is able to use the community cards to form a hand in conjunction with the first set of player cards dealt to each player;
receive a wagering decision from each player of the plurality of players during a first wagering round;
deal an additional community card to the community area of the table;
determine a winning player; and
determine an award to be received by the winning player.

8. The system of claim 7, wherein the server is further configured to receive wagering decisions during a second wagering round from each player of the plurality of players who remains in play after the additional community card is dealt to the community area.

9. The system of claim 8, wherein the server is further configured to deal a final community card to the community area upon a determination that at least two players remain in play after the wagering decisions have been received during the second wagering round.

10. The system of claim 9, wherein the server is further configured to receive wagering decisions during a third wagering round from each player of the plurality of players who remains in play after the final community card is dealt to the community area.

11. The system of claim 7, wherein each computing device is further configured to prevent each respective player from entering a wagering decision between a time the at least one player has entered the required wager and a time in which the predetermined number of community cards has been dealt.

12. The system of claim 7, wherein the server is configured to prevent the electronic gaming machines from receiving wagering decisions in more than three wagering rounds.

13. A method of providing a game of poker to a plurality of players at a poker table, said method comprising:
receiving a first required wager from a first player of a plurality of players;
receiving a second required wager from a second player of the plurality of players;
dealing a first set of player cards to each of the plurality of players;
automatically and without receiving a wagering decision from any of the plurality of players, dealing a predetermined number of community cards to a community area of the table, wherein each player of the plurality of players is able to use the community cards to form a hand in conjunction with the first set of player cards dealt to each player;
receiving a wagering decision from each player of the plurality of players during a first wagering round;
dealing an additional community card to the community area of the table; and
determining a winner of the game from among the players remaining in play.

14. The method of claim 13, further comprising receiving wagering decisions during a second wagering round from each player of the plurality of players who remains in play after the additional community card is dealt to the community area of the table.

15. The method of claim 14, further comprising dealing a final community card to the community area of the table upon a determination that at least two players remain in play after the wagering decisions have been received during the second wagering round.

16. The method of claim 15, further comprising receiving wagering decisions during a third wagering round from each player of the plurality of players who remains in play after the final community card is dealt to the community area of the table.

17. The method of claim 13, further comprising receiving wagering decisions from the plurality of players using a respective touch screen device operated by each of the plurality of players.

18. The method of claim 17, wherein each touch screen device is integrated within the table at a respective player station associated with each player.

19. The method of claim 13, further comprising preventing each player of the plurality of players from entering a wagering decision between a time the second player has entered the second required wager and a time at which the predetermined number of community cards has been dealt.

20. The method of claim 7, further comprising limiting the number of wagering rounds available during the poker game to no more than three wagering rounds.
